(19) United States
(12) Patent Application Publication
(10) Pub. No.: US 2024/0046336 A1
(43) Pub. Date: Feb. 8, 2024

(54) ORDER FULFILLMENT AND DELIVERY OF EQUINE PRODUCTS

(71) Applicant: SmartPak Equine LLC, Plymouth, MA (US)

(72) Inventors: Dodd Corby, Plymouth, MA (US); Rebecca Minard, Plymouth, MA (US); Lawrence Strong, Plymouth, MA (US)

(21) Appl. No.: 18/267,532

(22) PCT Filed: Dec. 14, 2021
(86) PCT No.: PCT/US21/63237

§ 371 Date: Jun. 15, 2023

Related U.S. Application Data
(60) Provisional application No. 63/125,439, filed on Dec. 15, 2020.

(51) Int. Cl. G06Q 30/0601; G06Q 10/083

(52) U.S. Cl. CPC G06Q 30/0635; G06Q 10/083

(57) ABSTRACT

Methods and systems are provided for ordering of purchases by multiples entities and delivery of those purchases with improved efficiencies and convenience.

### CROSS REFERENCE TO RELATED APPLICATION

This application claims the benefit of U.S. Provisional Application 63/125,439, filed on Dec. 15, 2020. The entire contents of this application is incorporated herein by reference in its entirety.

### FIELD

Embodiments of the invention are methods and systems for ordering of purchases by multiples entities and delivery of those purchases with improved efficiencies and convenience.

### BACKGROUND

A customer who purchases goods from a merchant can either pick up the purchased goods, or ask the merchant to send the goods. Typically the customer has to create a customer account with the merchant that includes at least shipping information.

The growth of electronic commerce also has enabled consumers to conduct a large percentage of their shopping online, resulting in a large volume of packages being delivered to homes and businesses.

Delivery of such packages to correct destinations can entail complex logistics and involve significant costs.

It thus would be desirable to have improved systems for purchase and delivery of goods.

### SUMMARY

We now provide methods and systems for efficient purchasing and delivery of items to a group of distinct purchasers.

We have found that substantial efficiencies can be realized by the present methods and systems, including savings on packaging materials and shipping costs.

More particularly, in one aspect, the present methods and systems may include providing a plurality of items purchased by multiple entities; and shipping the items to a single address or location for receipt by the multiple entities.

Preferably, one or more groups of items are shipped to a single address on the same date or day. That shipping date suitably can be selected to be periodic, for example, daily, weekly, biweekly, monthly, or other selected period.

In certain aspects, items ordered by one or more of the multiples entities are collected and stored by a seller at a designated location, particularly until a selected shipping date. Multiple items purchased by one entity at different times suitably may be collected and stored at a designated location, particularly until a selected shipping date.

In certain aspects, a purchased item is identified as associated with the group that includes multiple entities and then stored at a designated location until a selected shipping date. An entity of the group (i.e. purchaser) is suitably associated with the single address at the time of purchasing an item, in particular a purchaser may be linked to a single address prior to purchasing an item. Alternatively, a purchaser may affirmatively designate at the time of purchase that the purchased item is associated with the group and single shipment address.

We have found that the present methods are particularly useful for purchase and delivery of goods for domesticated and livestock animals such as horses, dogs, cats and other domesticated animals or cattle, sheep, pigs, chickens, ducks and other fowl, and other livestock.

In particular, the present methods and systems are particularly useful for a location or facility that is used or otherwise accommodates one or more members of the group, more preferably two or more members of the group, still more preferably three or more members or each member of the group. By such coordination, the purchased items can be readily and conveniently received by a plurality or each group member.

For example, in a preferred aspect, members of the group may be associated with a facility where the grouped purchases may be delivered and distributed or otherwise received by the members at the facility.

In particular, the facility may be a barn where each member houses one or more animals such as a horse. For example, in the case of a horse or equine barn, the barn may house multiple horse such as 2, 4, 6, 8, 10, 12, 14, 16, 18 or 20 or more horses that are owned by 2, 3, 4, 5, 6, 7, 8, 9 or 10 or more persons (group members). Each person of the group may purchase one or more items as desired such as by on-line ordering or by other method such as a call-in, text or regular mail order. In such preferred aspects, any of a variety of items may be suitably purchased, including food and supplement items that may be packaged for a specific horse. Each designated purchase made by any of the group members will be delivered periodically to the facility.

In another aspect, members of the group may be associated with a residential community, such as a multiple-unit residential building or collection of residential building(s) (e.g. an apartment or condominium complex), neighborhood or other residential area acid the like. The group members will be residents of the community, or have mail or delivery service access within the residential community. One or more members of the group will be designated (“Designated Member”) as receiving delivery of group-selected purchases of any group member typically on a periodic basis such as 1, 2 or 3 or more tines a week, or 1, 2, or 3 or more times a month.

Thus, in this aspect, a Designated Member may receive delivery of items purchased and identified for routing to the Designated Member by any group member. Delivery of multiple items to a single address (i.e. the Designated Member) can result in notable shipping efficiencies as well as enhanced security of the delivered items.

In preferred aspects, the methods are computer-implemented and may include online purchasing of the items to be delivered. The ordered items suitably may be electronically identified for storage and then delivery by the seller. More particularly, purchasing selections and designation to a delivery group can include sending one or more instructions to a controller based on inputs from the purchaser, including through an online format.

Other aspects of the invention are disclosed infra.

### BRIEF DESCRIPTION OF THE DRAWING

FIG. 1 shows schematically a preferred purchase and delivery method.

### DETAILED DESCRIPTION

We provide methods and systems that include providing a plurality of items purchased by multiple entities and shipping the items to a single address or location for receipt by the multiple entities.

In preferred systems, orders placed by one or more customers can be made at different times or dates, for example, within any time between a purchaser group's sequential scheduled shipping dates, or within a defined period before a scheduled shipping time/date. For instance, orders may be collected for shipment on a specified date to a single address or location, where the orders are placed by one or more purchasers at varying times prior to shipment, for instance, where orders are placed within a time as may be established by the vendor such as up to about 0.5, 1, 2, 3, 6, 12, 24, 36 or 48 hours (or more) before a specified shipping time/date.

Additionally, in certain preferred systems, orders placed by one or more customers each can be made by different methods. For example, one or more of the orders may be placed through an on-line process such as a website operated by the vendor or other group, one or more of the orders may be placed through a call-in (telephone, Skype, Zoom or other call-in access) order to the vendor or other group, and/or other electronic methods such as email or online live chat functionality. Thus, suitably two or more of the orders of a single shipment are placed by distinct methods by one or more purchasers. Also, orders suitably may be placed on a subscription-type basis, where the order or modified form of an order is automatically repeated on an established schedule such as once a week, every two weeks (biweekly), monthly, or other period.

Still further, in certain preferred systems, payment may be made by different methods for any particular item and by different members of a purchasing group. For example, payment may be made by credit card, bank or wire transfer, from an account established with the vendor, or other methods.

Referring now to particular exemplary preferred systems with reference to FIG. multiple purchasers 10 (Customers 1, 2, 3 and 4) may each make one or more purchases of the same or different items.

In certain aspects, the customers may be registered or otherwise identified prior to the purchasing event as being members of a group where purchases will be shipped to a common address, and preferably where the purchases will be packaged or otherwise collated in a specified area prior to shipping.

In certain embodiments, a computing device may receive data from a purchaser describing a purchase order to be prepared by the merchant and other details including that the purchaser is a member of the defined group. The purchase order may specify one or more items that were selected by the user for purchase for example from an electronic catalog. The electronic catalog suitably can be a catalog that includes items sold only by the merchant or a generic catalog that includes items sold by the merchant as well as other items sold by other merchants.

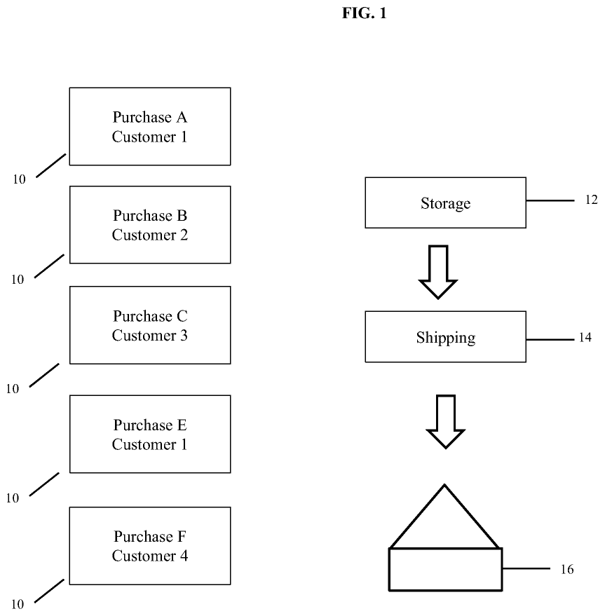

A computing device also may provide additional functions, for example to determine an order preparation time for a purchase order based on the one or more items specified in the purchase order; determine an order start time for instance based on the order preparation time and desired time to arrive at a merchant storage area 12 as shown in FIG. 1 or to be shipped 14.

As shown in FIG. 1, one or more purchased items are shipped to a single location 16.

In one aspect, the single location or address 16 may be a residential address. For example, a Designated Member of the purchasing group maybe a resident in a neighborhood or multi-unit building where other members of the purchasing group also reside. Upon receipt of a shipment of purchased items, members of the purchasing group may retrieve their purchased items from the Designated Member.

In another aspect, the single location or address 16 may be a non-residential address. In particularly preferred aspects, the single location or address 16 may be a barn, for example an equine barn where multiple horses that may are owned by members of the purchasing group.

In certain preferred systems, a member of a purchasing group has the option to the purchase any particular item, or to purchase a subset of items offered by the vendor, without the delivery coordinated and scheduled with other purchased items of the purchasing group. For instance, a member of the purchasing group may elect for one or more purchased items to be opted out of the purchasing group's scheduled delivery date, for example to provide an expedited delivery of the elected items, or otherwise have a delivery date other than purchasing group's scheduled delivery date.

In further preferred systems, the labeling or other physical designation associated with a purchased item or packaging for the item may be selected at the discretion of the vendor. For instance, in one aspect, at the time of ordering an item may be labelled with the purchaser's name or other identifier including in a unique manner. In addition to the purchaser's name, other identifiers that may be used in labelling could include the name of a horse other user of a purchased items or the name of a barn including horse barn or other location where a purchase items may be used or stored.

From the foregoing description, it can be apparent that variations and modifications may be made to the invention described herein to adopt it to various usages and conditions. Such embodiments are also within the scope of the following claims.

1. A method comprising:
establishing a purchaser group that 1) comprises multiple members and 2) has a single delivery address;
receiving a purchase order of one or more items from one or more members of the purchaser group;
shipping the items to the single address for receipt at the single address by one or more purchaser group members.

2. A method comprising:
providing items purchased by a purchaser group that comprises multiple members; and
shipping the items to a single address for receipt by the multiple entities.

3. The method of claim 1 wherein the single address is a residential address.

4. The method of claim 3 wherein the purchaser group members reside in the same neighborhood or building.

5. The method of claim 1 wherein the single address is a non-residential address.

6. The method of claim 1 wherein the single address is an equine barn.

7. The method of claim 1 wherein the one or more items are shipped on the same date.

8. The method of claim 1 wherein the one or more items are shipped on a periodic date.

9. The method of claim 1 wherein items ordered by one or more purchaser group members are collected and stored at a designated location until a selected shipping date.

10. The method of claim 1 wherein the one or more items are moved to a shipping area on the same date.

11. The method of claim 1 wherein a purchaser group member is associated with the single address at the time of purchasing an item.

12. The method of claim 1 wherein a purchaser group member associates an item with the single address at the time of purchasing the item.

13. The method of claim 1 wherein a purchaser group member is linked with the single address prior to purchasing an item.

14. The method of claim 1 wherein a purchaser group member may schedule delivery of a purchased item for any future date.

15. The method of claim 14 wherein the item delivery date is selected for the purchaser group's scheduled delivery date.

16. The method of claim 14 wherein the item delivery date is selected for a date different than the purchaser group's scheduled delivery date.

17. The method of claim 1 wherein the one or more of the members purchases items by differing methods.

18. The method of claim 1 wherein the one or more of the members makes payment for items by differing methods.
